(19) United States
(12) Patent Application Publication
(10) Pub. No.: US 2006/0055749 A1
(43) Pub. Date: Mar. 16, 2006

(54) Ink reservoir for automatic recording, writing, and drawing devices

(76) Inventors: Rainer Schuster, Hersbruck (DE); Stefan Engel, Ruckersdorf (DE)

Correspondence Address: Friedrich Kueffner;Suite 910, 317 Madison Avenue, New York, NY, 10017, US

(21) Appl. No.: 11/229,048

(22) Filed: Sep. 16, 2005

(30) Foreign Application Priority Data
Sep. 16, 2004 (DE) 10 2004 044 744.6

(51) Int. Cl. B41J 2/175

(52) U.S. Cl. 347/86

(57) ABSTRACT

An ink reservoir or tank for automatic recording, writing, and drawing devices, particularly ink-jet systems, such as printers and plotters, wherein a sleeve or bandage is arranged within the ink reservoir. The ink pouch and the printing device are entirely or partially surrounded by the sleeve or bandage. In addition, the sleeve or bandage is constructed with respect to shape and dimensions in such a way that a free space exists between the outer wall of the sleeve or bandage and the inner side of the housing wall of the ink reservoir.

### BACKGROUND OF THE INVENTION

1. Field of the Invention

The present invention relates to an ink reservoir or tank for automatic recording, writing, and drawing devices, particularly ink-jet systems, such as printers and plotters.

2. Description of the Related Art

Ink reservoirs for devices of the above-described type are known in principle.

DE 102 27 225 A1 shows and describes an ink reservoir with a stiff housing with a compressable ink pouch in the housing, wherein a pressing device for compressing the flexible ink reservoir is coupled to the ink pouch. This tank or reservoir has the disadvantage that the pressure system composed of pressing device and ink reservoir rests against the housing, so that the housing expands in the shape of a drum which has the result that the reservoirs are no longer removable or are only removable by applying high forces from the ink compartment of the printer.

In addition, US 2001/0024225 A1 discloses an ink reservoir in which an ink pouch is placed in a hermetically enclosed reservoir housing. The interior of the reservoir receives compressed air from a valve connection, so that the flexibly constructed ink reservoir folds up and the ink in the ink reservoir is pressed out. This has the disadvantage that the reservoirs to which pressure is admitted bulge or become untight which has the result that a pressure drop occurs and the ink supplied to the printing head is interrupted. The reservoirs are also structurally very complicated and require a plurality of reinforcing ribs in order to counteract any deformation.

The problem of bulging or expanding reservoirs occurs generally in all known types of pressure tank systems.

### SUMMARY OF THE INVENTION

It is the object of the present invention to provide an ink reservoir which does not have the disadvantages discussed above and which permits an easy removal of the used, partially empty or empty reservoir from the printer.

In accordance with the present invention, a sleeve or bandage is arranged within the ink reservoir. The ink pouch and the printing device are entirely or partially surrounded by the sleeve or bandage. In addition, the sleeve or bandage is constructed with respect to shape and dimensions in such a way that a free space exists between the outer wall of the sleeve or bandage and the inner side of the housing wall of the ink reservoir.

The various features of novelty which characterize the invention are pointed out with particularity in the claims annexed to and forming a part of the disclosure. For a better understanding of the invention, its operating advantages, specific objects attained by its use, reference should be had to the drawing and descriptive matter in which there are illustrated and described preferred embodiments of the invention.

### BRIEF DESCRIPTION OF THE DRAWING

In the drawing:

FIG. 1 is a longitudinal sectional view of the ink reservoir according to the present invention:

FIG. 2 is a transverse sectional view of the ink reservoir of FIG. 1;

FIG. 3 is a sectional view of an ink reservoir according to the present invention with a spring mechanism as the pressing device; and

FIG. 4 is a perspective view of a sleeve according to the present invention.

### DETAILED DESCRIPTION OF THE PREFERRED EMBODIMENTS

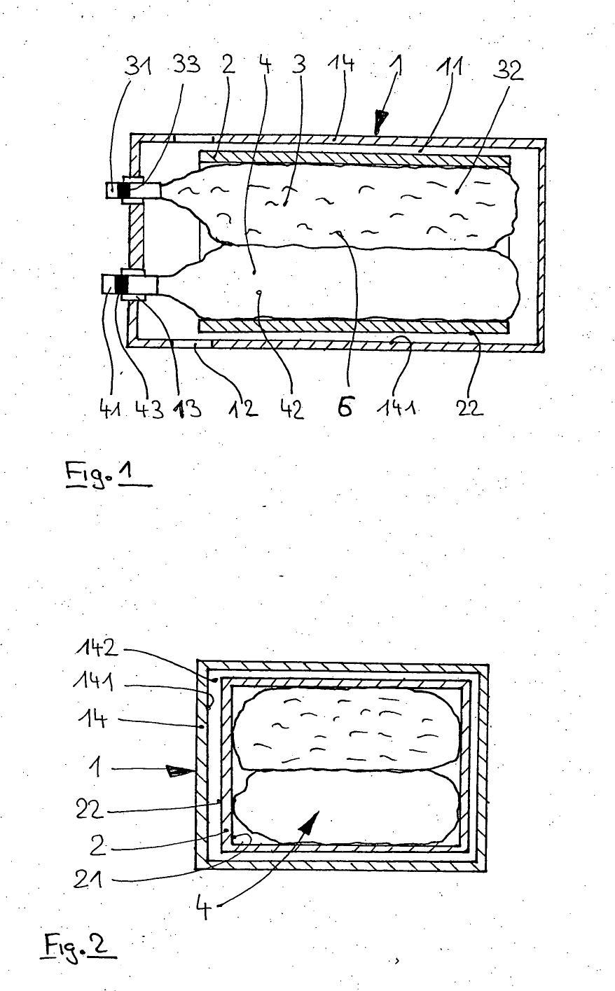

FIG. 1 of the drawing shows the principal configuration of an ink reservoir 1 proposed in accordance with the present invention, wherein the inner space 11 of the reservoir is defined by the housing wall 14. Arranged in the interior 11 of the reservoir are the ink pouch 3 for storing ink 6 in the interior 32 of the pouch and the air bag 4, wherein the ink reservoir 3 and the air bag 4 are surrounded by a bandage 2. The illustrated ink reservoir 3 as well as the air bag 4 are constructed of a flexible material. The interior 42 of the air bag 4 is subjected to a pressure medium, preferably compressed air, so that the interior 42 expands and presses the ink 6 contained in the interior space 32 of the pouch from the ink pouch 3. The bandage or sleeve 2 always ensures that no forces act on the inner side 141 of the housing through the air bag 4 through which compressed air is admitted.

No forces act between the outer wall 22 of the bandage 2 and the inner side 141. Any forces which occur during the printing operation as a result of pressure expansion of the air pouch 4 act at all times only against the inner wall 22 of the bandage 2. The housing wall 14 may have one or several break-throughs 12, so that no excess pressure builds up in the interior 11 of the reservoir which would lead to a deformation in the form of bulges in the reservoir. In the illustrated embodiment, the housing wall 14 of the ink reservoir 1 has two connecting openings 13 for ink connection 31 and air connection 41. The ink connection 33 and/or the air connection 43 may be configured as valves or septums.

FIG. 2 shows the ink reservoir 1 of FIG. 1 in a cross-sectional view. This figure clearly shows that a free space 142 is provided between the housing interior 141 and the outer wall 22 of the bandage 2, so that it is ensured that no forces act between opposite sides of the housing wall 14 of the ink reservoir 1. Any forces which are generated during the expansion of the pressure device 4 act at this time only against the inner wall 21 of the sleeve or bandage 2.

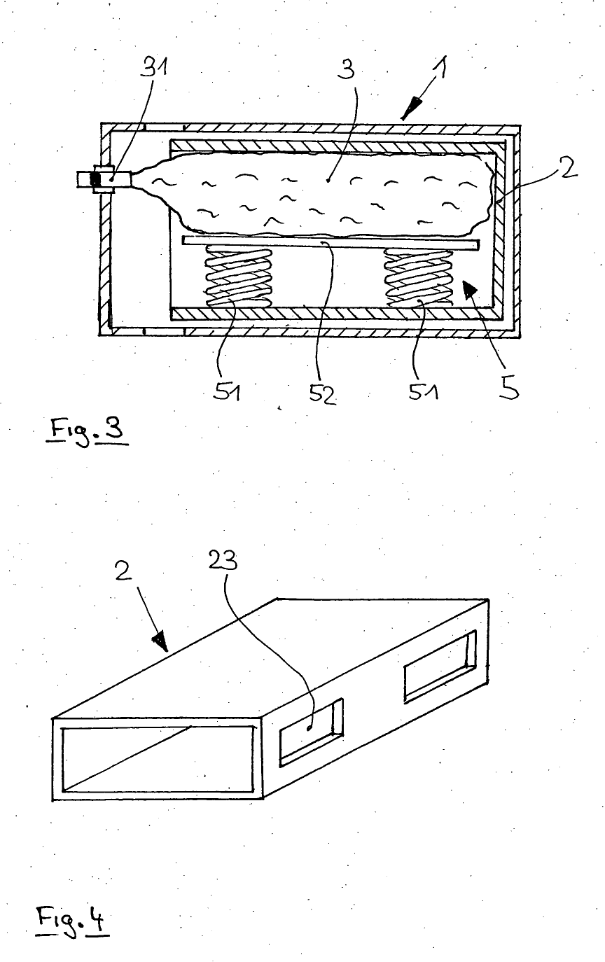

FIG. 3 shows another embodiment of the ink reservoir 1 according to the present invention. In this embodiment, the pressure device 5 acts as a compression spring 51 and acts on the ink pouch 3 through the spring plate 52. The illustrated sleeve 2 is closed at one end thereof. Acordingly, this embodiment only has one ink connection 31.

FIG. 4 shows a sleeve or bandage 2 as a separate component. The illustrated embodiment includes recesses 23, wherein the shape of these recesses is entirely insignificant. The recesses 23 in the sleeve 2 make it possible to reduce the weight, if necessary.

It has been found to be advantageous if the sleeve or bandage 2 is constructed as a bending-stiff component, so that it is ensured that no forces act at any time against the oppositely located walls 14 of the ink reservoir 1. This is the case if the free space 142, shown and described in FIG. 2, is no longer provided.

Of course, the bandage can also be composed of a net, adhesive tape, or other bag or sleeve-like components if these ensure that no forces are transmitted to oppositely located housing walls of the ink reservoir.

There are essentially no limits with respect to the configuration of the bandage. It is possible to close the bandage at one or both end sides. It is only important in this connection that break-throughs for the ink and/or air connections are formed.

The sleeve or bandage is shaped and dimensioned in such a way that a free space is formed between the outer wall of the sleeve or bandage and the inner side of the housing wall of the ink reservoir. The sleeve or bandage can also be constructed as a component which is separate from the ink reservoir.

The sleeve or bandage may be attached, for example, glued, to the inner side of the housing wall, so that no rattling noises occur as a result of the free space which acts against the inner side of the housing wall. No clapping noises should be heard.

Alternatively, the sleeve or bandage can also be constructed as a single piece with the ink reservoir, wherein, however, a free space or expansion space is formed between the ink reservoir and sleeve with respect to the three space coordinates, so that it is ensured that no forces are introduced into the housing wall of the reservoir during the printing operations.

The pressing device may be a flexible air bag, a compression spring, or other mechanical pressure generator.

1. In an ink reservoir for an ink jet printing system, a printer, plotter, or other automatic recording, writing, or drawing device, wherein the ink reservoir comprises, a housing, a flexible ink pouch, and a printing device, wherein the ink pouch and the pressure device are arranged within the housing, wherein the improvement comprises that a sleeve or bandage is arranged within the ink tank,
the ink bag and the pressure device are surrounded entirely or partially by the sleeve or bandage; and
the sleeve or bandage are constructed with respect to shape and dimension in such a way that a free space is formed between the outer wall of the sleeve or bandage and the inner side of the housing wall of the ink reservoir.

2. The reservoir according to claim 1, wherein the sleeve or bandage is a component which is separate from the ink reservoir.

3. The reservoir according to claim 2, wherein the sleeve or bandage is attached to the inner side of the housing wall.

4. The reservoir according to claim 3, wherein the sleeve or bandage is formed in one piece with the ink reservoir, wherein a free space or expansion space is provided between the ink pouch and the sleeve, or an expansion space is constructed in the three space coordinates.

5. The reservoir according to claim 1, wherein the pressure device is a flexible air bag.

6. The reservoir according to claim 1, wherein the pressure device is constructed as a compression spring or other mechanical pressure generator.
